(19) United States
(12) Patent Application Publication
(10) Pub. No.: US 2014/0060922 A1
(43) Pub. Date: Mar. 6, 2014

(54) FASTENING DEVICE FOR A LINE AND METHOD FOR FASTENING A LINE

(71) Applicants: Gerd Weyrich, Ruhla (DE); Helko Rausch, Waltershausen (DE); Frank Weishaeutel, Wangenheim (DE); Rolf Bischof, Fischbach (DE); Erasmo Cachay Mateos, Leinfelden-Echterdingen (DE); Lars Ritter, Eisenach (DE); Anwar Hegazi, Frienstedt (DE); Jessica Kleine, Gotha (DE)

(72) Inventors: Gerd Weyrich, Ruhla (DE); Helko Rausch, Waltershausen (DE); Frank Weishaeutel, Wangenheim (DE); Rolf Bischof, Fischbach (DE); Erasmo Cachay Mateos, Leinfelden-Echterdingen (DE); Lars Ritter, Eisenach (DE); Anwar Hegazi, Frienstedt (DE); Jessica Kleine, Gotha (DE)

(21) Appl. No.: 13/883,484

(22) PCT Filed: Sep. 12, 2011
(86) PCT No.: PCT/EP11/65750

§ 371 Date: Sep. 27, 2013

(30) Foreign Application Priority Data
Nov. 8, 2010 (DE) 10-2010-043-565.1

(51) Int. Cl. H02G 3/04

(52) U.S. Cl. CPC H02G 3/0406
USPC 174/70 R; 29/525.03

(57) ABSTRACT

A fastening device, e.g., for an electrical cable in a vehicle, has a sleeve which is lockable in a holder and which encloses the line. The sleeve has at least two sleeve subareas which are at least partially separable from one another in such a way that in a preinstalled state the line is inserted into an inner area of the sleeve, and the sleeve subareas are connectable to one another in such a way that in an installed state the line is completely annularly enclosed by the sleeve subareas. Due to the multipart configuration of the sleeve, it is easily mounted on a line. A resistant material such as a thermoplastic elastomer, which is processable with the aid of injection molding, is used for the sleeve.

### BACKGROUND OF THE INVENTION

1. Field of the Invention

The present invention relates to a fastening device for fastening a line to a holder, in particular for fastening an electrical cable in a vehicle. Moreover, the present invention relates to a method for fastening a line with the aid of a fastening device according to the present invention.

2. Description of the Related Art

Fastening devices are known from published German patent application document DE 10 2008 008 562 A1, for example, via which lines, for example in the form of flexible electrical cables, may be fastened or locked in place on a holder. The line is enclosed in a sealing manner by a so-called sleeve, sometimes also referred to as a support sleeve. The sleeve may establish an elastic mechanical connection between the line and the holder. For example, the sleeve may have recesses, in particular in the form of grooves, which may be pushed in to fit into recesses in the holder, and may cooperate with same in a form-locked manner.

Such sleeves are used for various purposes, in particular in motor vehicles. For use in vehicle areas that are dynamically stressed, the sleeve may be configured with a static functional area and a dynamic functional area. The static functional area may have a design that is relatively mechanically rigid and nonelastic, so that this functional area may be securely fastened to the holder. The dynamic functional area should be as flexible as possible in order to be able to follow the movements of the cable to be fastened. For use in vehicle areas that are subject only to static stress, it may be sufficient to provide a sleeve having only a static functional area.

Previous sleeves have usually been designed in such a way that as a one-piece component they completely annularly enclose the line or the cable in the installed state. To allow fastening of the line to the holder, the sleeve must initially be mounted on the line. In this regard, there are generally two fastening methods for mounting the sleeve on the line:

On the one hand, the sleeve may be manufactured and provided in advance as a one-piece, annularly closed component. It must then be spread apart, or inflated by compressed air, to allow it to be mounted on the line and to axially guide the line through a central opening in the sleeve. When the sleeve reaches the position at which the cable is to be held when fastened to the holder, the spreading of the sleeve is discontinued, and due to its elastic material properties the sleeve places itself tightly around the cable.

However, in this fastening method the line or the cable must have a free end; i.e., plugs, for example, must not have been installed beforehand on the cable. Furthermore, the spreading of the sleeve which is necessary for fastening may entail an additional expenditure of effort. The quantity of material needed for the sleeve may be considerable, and may contribute to the overall costs in fastening the line.

In an alternative fastening method, sleeves may be directly molded onto the line or the cable with the aid of injection molding. The material costs and the quantity of material to be used may be small compared to sleeves to be mounted. However, expensive tools must be provided for the injection molding process, so that the costs of molding on the sleeve may contribute significantly to the overall costs of the fastening method.

### BRIEF SUMMARY OF THE INVENTION

There may be a need for an alternative fastening device for a line, and a method for fastening a line, in which disadvantages of conventional sleeves and fastening devices may be at least partially reduced.

According to a first aspect of the present invention, a fastening device for a line, in particular for an electrical cable in a vehicle, is proposed. The fastening device has a sleeve which may enclose the line, and via which the line may be locked in place on a holder. For this purpose, the sleeve has a contour which may be detachably fastened in a recess in the holder. The sleeve, at least in places, is made of an elastically deformable material. As a characterizing feature, the sleeve has at least two sleeve subareas which are at least partially separable from one another in such a way that in a preinstalled state the line may be inserted into an inner area of the sleeve, and in addition the sleeve subareas are connectable to one another in such a way that in an installed state the line is completely annularly enclosed by the sleeve subareas which are connected to one another.

An essential concept concerning the fastening device proposed herein may be seen in the fact that the sleeve does not have to have a one-piece annular design in order to be able to completely enclose the line, but, rather, may be composed of the sleeve of at least two pieces, also referred to herein as sleeve subareas. The two sleeve subareas may be two completely separate components which may be completely separated from one another in the preinstalled state, i.e., before the sleeve is put together around the line. For the installed state, the sleeve subareas may then be put together and connected to one another in order to completely annularly enclose the line. In this installed state the sleeve may then be locked in place on the holder, thus fixing the line to the holder in a sealing manner.

Alternatively, the sleeve subareas may already be connected to one another, at least in some areas, in the preinstalled state. However, the two sleeve subareas each have at least one side edge, and in the preinstalled state these side edges are not connected to one another. The line may be inserted into the sleeve at this side edge.

For example, the sleeve subareas may be connected to one another along a side edge. However, the mechanical connection of the sleeve subareas in the preinstalled state should be designed in such a way that the sleeve subareas are still separable from one another in such a way that the line may be inserted into an inner area which in the installed state represents the interior of the annularly enclosed sleeve. For example, two sleeve subareas may be provided which are connected to one another only at one of their two side edges, the respective other side remaining free, so that the sleeve, which is composed of the two sleeve subareas, may be opened around the mutually connected side edges in order to insert the line. As a result of the partial connection of the sleeve subareas, it is possible for only a single component, composed of the two mutually connected sleeve subareas, to have to be provided and processed during the fastening of the line.

In this embodiment, the at least two sleeve subareas may even be provided as a single component in which the two sleeve subareas are connected to one another via a thin, flexible plastic skin, for example. The two sleeve subareas may be folded together due to the flexibility of this plastic skin. The sleeve subareas and the connecting plastic skin may be made as one piece, and from the same material. Alternatively, the sleeve subareas may be connected to one another with the aid of a separate hinge or a tension spring.

To subsequently connect the sleeve subareas to one another for the installed state, the sleeve subareas may be designed in such a way that they may be clipped together in a form-locked manner. For this purpose, protrusions may be provided on a first sleeve subarea, for example, and complementary recesses may be provided at the appropriate position on a second sleeve subarea. In order to connect the two sleeve subareas to one another, the protrusions may be clipped into recesses.

Alternatively or additionally, the sleeve subareas may be designed to be connected to one another by gluing, heat-sealing, or joining. For this purpose, the sleeve subareas may be appropriately pretreated or configured, for example, at surfaces which come into contact with one another in the installed state. For example, the sleeve subareas may be provided with a material at the contact surfaces which may be liquefied by heat input in order to allow heat-sealing of the sleeve subareas.

While form-locked clipping of the sleeve subareas may allow very simple and rapid installation of the sleeve, connecting the sleeve subareas by gluing, heat-sealing, or joining may allow a simple and cost-effective design of the sleeve subareas, and also may allow a very reliable mechanical connection of the sleeve subareas.

The sleeve subareas may be made of a thermoplastic elastomer (TPE). For example, the sleeve subareas may be made of polyurethane (PUR), in particular polyurethane based on polyether. Such materials may allow very cost-effective manufacture of the sleeve, and at the same time, sufficient mechanical flexibility of the sleeve.

In one particular embodiment, the sleeve subareas may be made of an essentially nonelastic material, at least in a connecting area in which the sleeve subareas are connected to one another in the installed state. It may thus be taken into account that the sleeve may not need to be elastic all over. In particular in the areas in which the sleeve subareas are to be reliably connected to one another in the installed state, it may be advantageous to dispense with elastic deformability. Therefore, in these connecting areas the sleeve subareas may be made of a nonelastic rigid material. This may be advantageous in particular in the above-described exemplary embodiment in which the sleeve subareas are to be clipped to one another, since the relatively rigid connecting areas may be easily and reliably clipped together.

The sleeve subareas may advantageously be manufactured with the aid of an injection molding process. For this purpose, the sleeve subareas may in particular be made of materials which are processable in the injection molding process. The injection molding process allows a very flexible geometric design of the sleeve subareas. In addition, it allows very cost-effective manufacture of the sleeve. For the case that the sleeve subareas are to be made of an elastically deformable material as well as a nonelastic material in their connecting areas, a two-component injection molding process may be used. Another option is to produce the clip connection as a separate component, for example as an insert, having a material that is suitable for clip connections, and to subsequently extrusion-coat same with the actual sleeve material.

The sleeve may be designed with two sleeve subareas which are symmetrical with respect to one another. The symmetry allows simple, cost-effective manufacture. In particular, the sleeve may be composed of two identical halves.

In another aspect of the present invention, a method is proposed for fastening a line with the aid of a fastening device having the design as described above. The fastening device is initially provided in a preinstalled state in which the sleeve subareas are at least partially separated from one another. In this preinstalled state, the line may be inserted into an inner area of the sleeve. In this regard, “insertion ” is to be understood not as axially passing the line through an annular opening in the sleeve, as is known in the conventional one-piece annularly closed sleeves, but, rather, as introducing the line into the inner area from one side, transversely with respect to the axial direction of the sleeve. After the line is inserted, in an installed state the sleeve subareas may be connected to one another in such a way that the line is completely annularly enclosed by the sleeve subareas which are connected to one another. Lastly, the sleeve with the line accommodated therein may be locked in place on a holder.

The proposed fastening device and the proposed method for fastening a line allow alternative options for fastening sleeves to a line, for example an electrical cable. Inexpensive material such as a thermoplastic elastomer having good material properties, for example with respect to media resistance or abrasion resistance, may be used. In addition, cable assembly for a variety of products may be flexibly designed. Furthermore, cable assembly which from a cost standpoint is independent of location is achieved with the proposed concept.

Aspects and specific embodiments as well as advantages of the present invention are described, in part with reference to a fastening device according to the present invention and in part with reference to a fastening method according to the present invention. However, those skilled in the art will recognize that the individual aspects and components may be suitably combined with one another to arrive at further specific embodiments of the present invention.

### BRIEF DESCRIPTION OF THE DRAWINGS

FIG. 1 shows a side view of a sleeve having a static functional area and a dynamic functional area.

FIG. 2 shows a side view of a sleeve having only a static functional area.

FIG. 3 shows a schematic perspective illustration of a holder for a fastening device.

FIG. 4 shows a sleeve subarea which may form a sleeve by clipping it together with an identical sleeve subarea.

FIG. 5 shows a clip bracket which is integrated into the sleeve subarea shown in FIG. 4.

FIG. 6 shows two sleeve subareas which are connectable to one another by joining them together.

FIG. 7 shows two sleeve subareas, having a dynamic functional area, which are connected to one another at one edge.

FIG. 8 shows a sleeve subarea, having a dynamic functional area, which may form a sleeve by clipping it together with an identical sleeve subarea.

FIG. 9 shows two sleeve subareas which may be clipped together and which are connected to one another at one edge.

FIG. 10 shows two sleeve subareas which may be glued together and which are connected to one another at one edge.

The drawings are strictly schematic and not to scale.

### DETAILED DESCRIPTION OF THE INVENTION

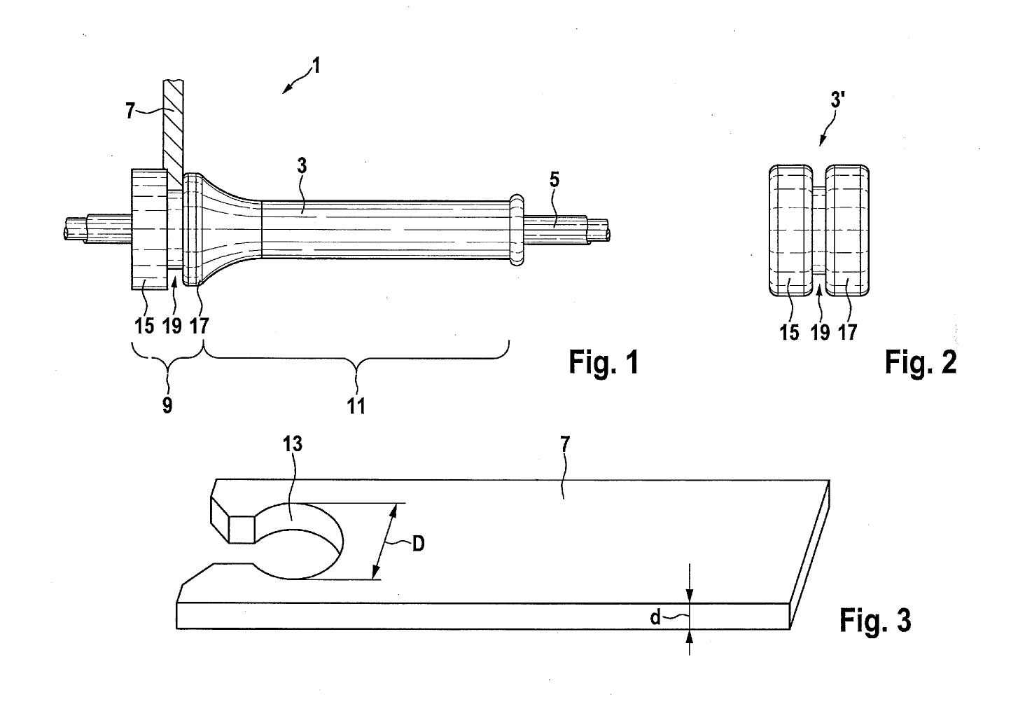

FIG. 1 shows a side view of a fastening device 1 in which a sleeve 3 completely encloses a line 5 which is designed as an electrical cable and is locked in place on a holder 7. Line 5 may thus be securely fastened, for example inside a vehicle, with the aid of sleeve 3. Sleeve 3 has a static functional area 9 at which sleeve 3 is locked in place on holder 7. In addition, sleeve 3 has a dynamic functional area 11 which encloses line 5 away from holder 7, and which due to its flexibility may reliably hold line 5 in a sealing manner, even under dynamic stress.

FIG. 2 shows a sleeve 3′ having only a static functional area and no dynamic functional area.

FIG. 3 shows a perspective view of a holder 7 to which sleeves 3, 3′ may be locked in place. Holder 7 has a circular recess 13 into which sleeves 3, 3′ may be introduced and locked in place therein.

In the area of their lock on holder 7, sleeves 3, 3′ have two flange-like ridges 15, 17 which delimit a groove-shaped contour 19, and which after installation adjoin recess 13 at both sides at the surfaces of holder 7. An outer diameter of groove-shaped contour 19 essentially corresponds to an inner diameter D of recess 13 in holder 7.

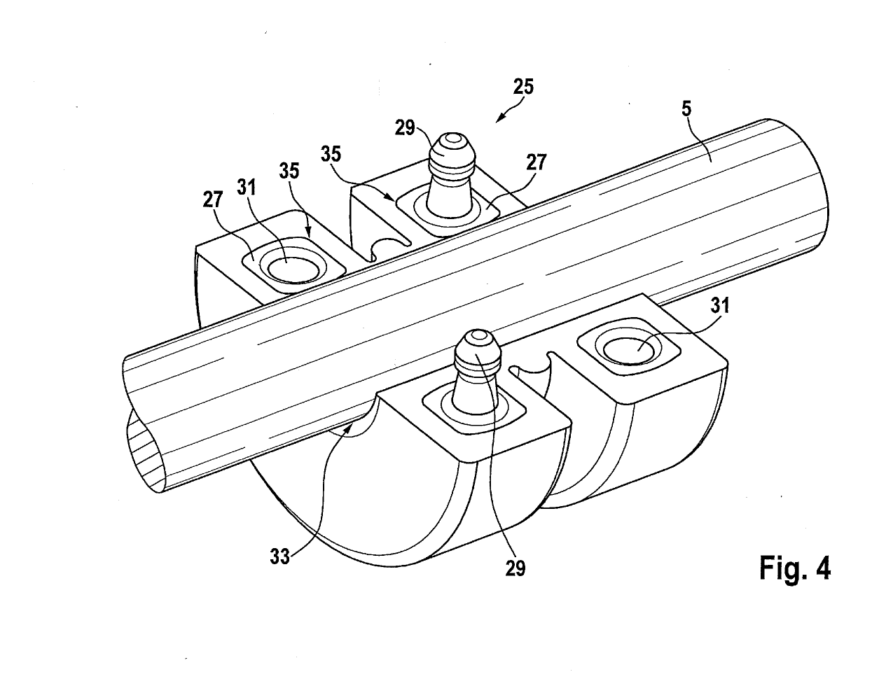

FIG. 4 shows an embodiment of a sleeve subarea 25. Sleeve subarea 25 is designed as one-half of a sleeve having an overall cylinder-like shape. Small protruding pegs 29 are provided at sleeve subarea 25. In addition, recesses 31 are formed in sleeve subarea 25, and have a shape that is approximately complementary to the shape of pegs 29. Corresponding pegs 29 and recesses 31 are likewise provided at corresponding positions in a complementary sleeve subarea (not illustrated). Pegs 29 and recesses 31 are provided with the aid of a bracket 27 which is integrated into sleeve subarea 25. This bracket 27 is made of an essentially nonelastic material, and thus forms a rigid connecting area 35 which may be used to establish a clipped connection of two sleeve subareas. Rigid bracket 27 is surrounded by an elastic material which forms the external shape of the sleeve and which is sufficiently elastic to allow insertion into holder 7.

The two sleeve subareas 25, which in the preinstalled state are present as separate components, may be clipped together in the installed state with the aid of pegs 29 and recesses 31. For installation, a line 5 is inserted into a tube-like recess in the two sleeve subareas which forms an inner area 33 and extends in the axial direction. The two sleeve subareas are subsequently connected to one another by clipping them together so that they completely annularly enclose line 5.

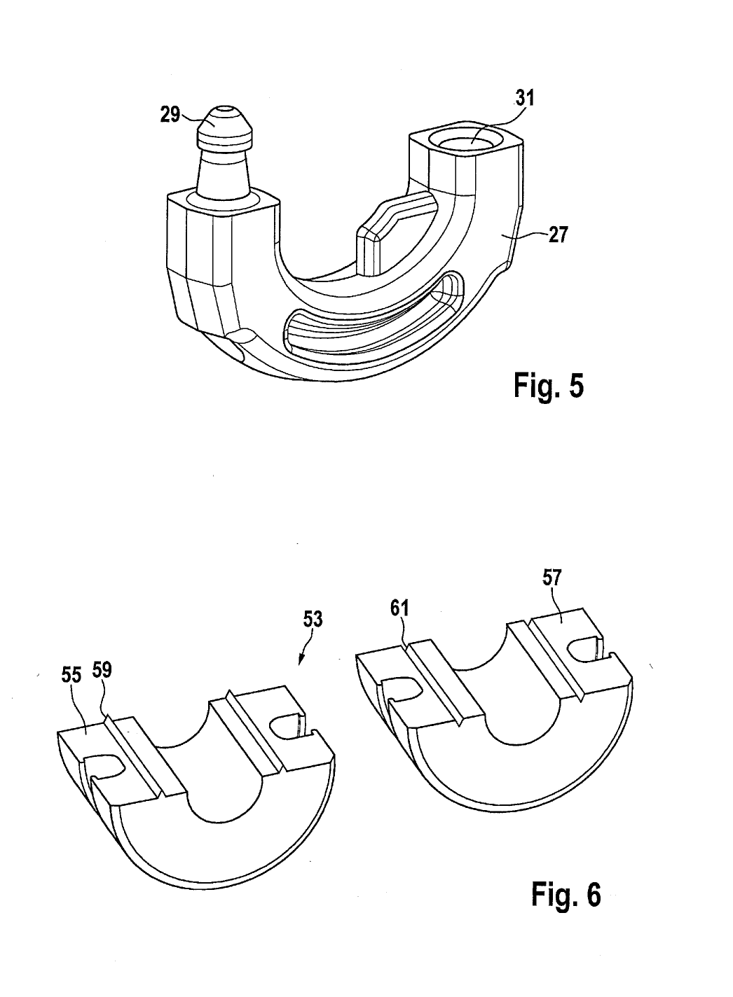

FIG. 5 shows a bracket 27 which is integrated into sleeve subarea 25 shown in FIG. 4.

FIG. 6 shows an alternative specific embodiment of a sleeve 53 in which the two sleeve subareas 55, 57 may be connected to one another by joining them together. For this purpose, sleeve subarea 55 is provided with an elongated protrusion 59 which extends in the longitudinal direction of the sleeve, and which may be joined to a groove 61 in the other sleeve subarea 57, and may thus ensure a stable connection of the two sleeve subareas 55, 57.

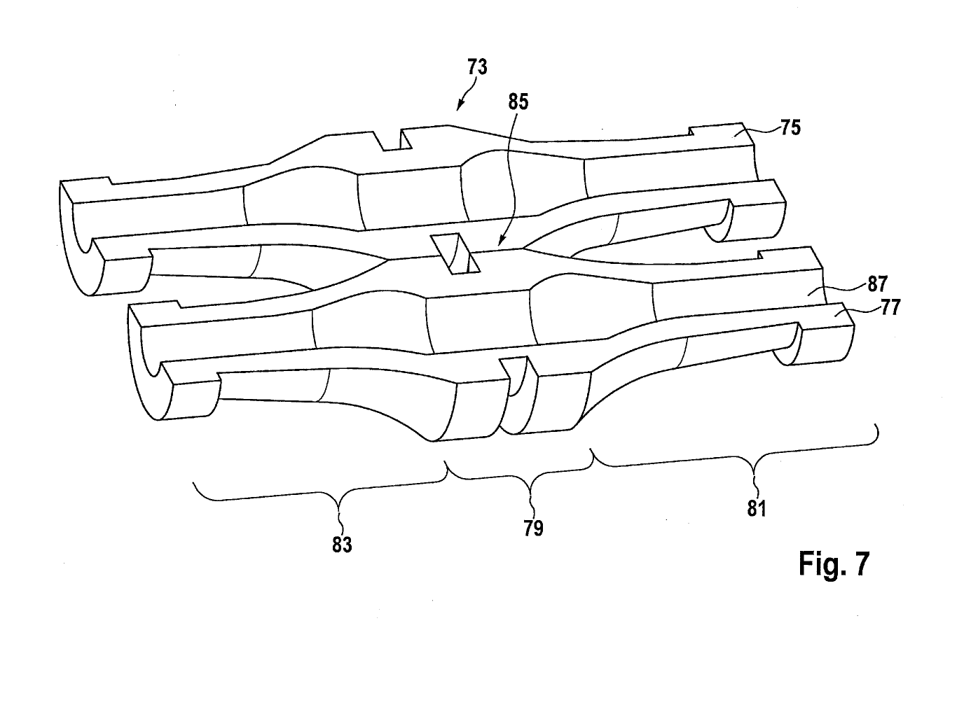

FIG. 7 shows a sleeve 73 composed of two symmetrically configured sleeve subareas 75, 77. Sleeve 73 has a static functional area 79 and two dynamic functional areas 81, 83. The two sleeve subareas 75, 77 are connected to one another along a side edge 85 via a thin plastic skin. The two sleeve subareas 75, 77 together with thin plastic skin 85 may be produced as a single integral component, for example in the injection molding process. Due to the flexibility of thin skin 85, the two sleeve subareas 75, 77 may be folded together and then connected to one another so that they enclose an inner area 87 in the installed state.

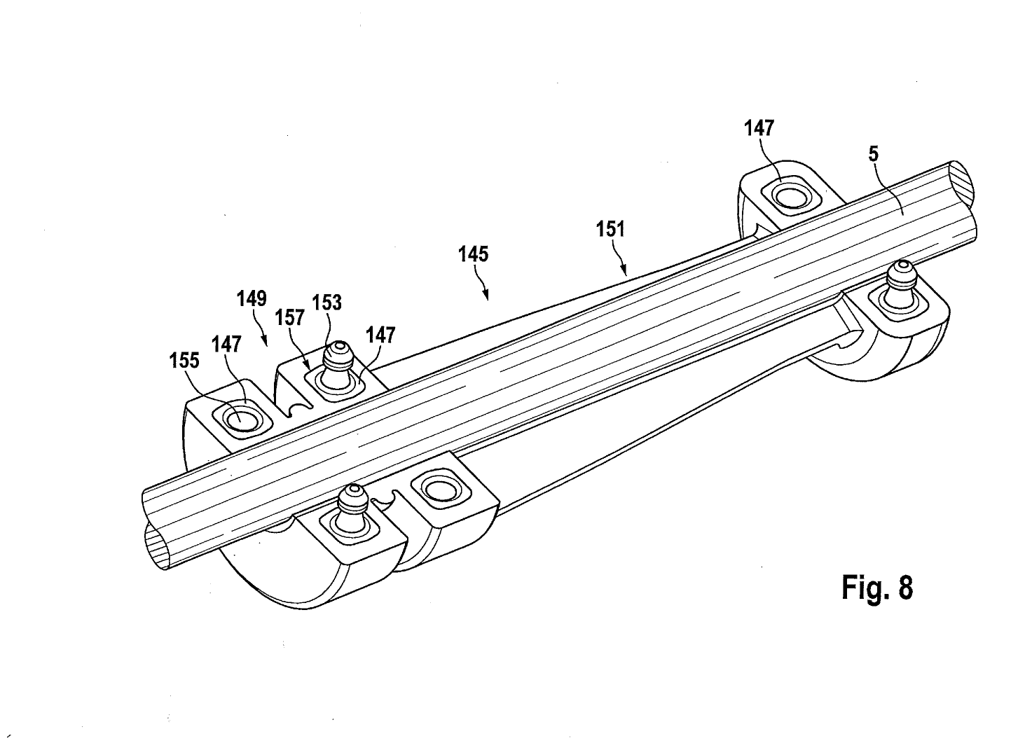

FIG. 8 shows a sleeve subarea 145 having a static functional area 149 and a dynamic functional area 151. Similarly as for sleeve subarea 25 shown in FIG. 4, multiple rigid brackets 147 are integrated into an elastic material, and with the aid of pegs 153 and complementary recesses 155 form connecting areas 157.

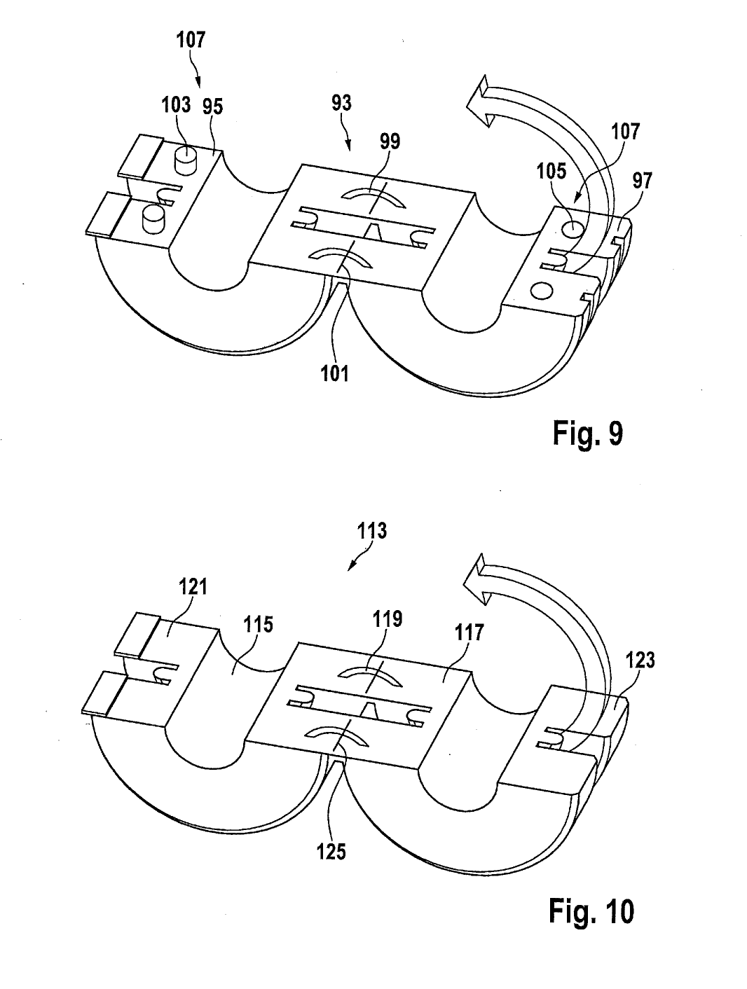

FIG. 9 shows another embodiment of a sleeve 93 in which two sleeve subareas 95, 97 are already connected to one another in the preinstalled state by a tension spring 99 or a hinge at a side flank 101. After a cable has been inserted into the interior of unfolded sleeve 93, the two sleeve subareas 95, 97, as indicated by the arrow in FIG. 7, may be folded together, and clipped to one another with the aid of protrusions 103 and complementary recesses 105, and may thus be securely connected to one another. A connecting area 107 in which protrusions 103 and recesses 105 connect the two sleeve subareas to one another in the installed state may be made of an essentially nonelastic material.

FIG. 10 shows another specific embodiment of a sleeve 113 in which two sleeve subareas 115, 117 are once again connected to one another along adjoining edges 125 via tension springs 119. Surfaces 121, 123 at which the two sleeve subareas 115, 117 abut one another in the folded-together, installed state are designed with regard to the material used or a surface pretreatment in such a way that they may either be heat-sealed together, or glued together, for example with the aid of adhesive pouches or UV adhesives.

The described sleeves may be easily and cost-effectively manufactured in the injection molding process, for example. Elastic materials, such as thermoplastic elastomers (TPE), may be used which at room temperature have characteristics that are comparable to the classical elastomers, but which may be plastically deformed under heat input and thus show thermoplastic behavior.

The sleeve may be easily fastened to a line due to the multipart design of the sleeve in the proposed fastening device. The sleeve may be folded or laid around the line, for example, and does not have to be axially pushed onto the line as with conventional sleeves. Therefore, sleeves may also be subsequently mounted on the line, although plug connectors, for example, have been attached to the line beforehand. Due to this design of the sleeves, cable assembly in vehicle manufacturing, for example, may be flexibly adapted for a variety of products.

1-10. (canceled)

11. A fastening device for an electrical cable in a vehicle, comprising:
a holder; and
a sleeve enclosing the cable, wherein the sleeve is elastically deformable and configured to be detachably fastened in a recess in the holder;
wherein the sleeve has at least two sleeve subareas which are at least partially separable from one another in such a way that in a preinstalled state the cable is inserted into an inner area of the sleeve, and wherein the sleeve subareas are connectable to one another in such a way that in an installed state the cable is completely annularly enclosed by the sleeve subareas which are connected to one another.

12. The fastening device as recited in claim 11, wherein the sleeve subareas are configured to be connected to one another by form-locking clipping.

13. The fastening device as recited in claim 11, wherein the sleeve subareas are configured to be connected to one another by one of gluing, heat-sealing, or joining.

14. The fastening device as recited in claim 12, wherein in the preinstalled state the sleeve subareas in each case are connected to one another along a side edge.

15. The fastening device as recited in claim 14, wherein the sleeve subareas are connected to one another at the side edge by one of a plastic skin, a hinge, or a tension spring.

16. The fastening device as recited in claim 15, wherein the sleeve subareas are made of a thermoplastic elastomer.

17. The fastening device as recited in claim 15, wherein at least in a connecting area in which the sleeve subareas are connected to one another in the installed state, the sleeve subareas are made of a non-elastic material.

18. The fastening device as recited in claim 15, wherein the sleeve subareas are injection molded thermoplastic.

19. The fastening device as recited in claim 16, wherein the sleeve has two sleeve subareas which are symmetrical with respect to one another.

20. A method for fastening an electrical cable with the aid of a fastening device having a holder and a sleeve configured to enclose the cable, wherein the sleeve is elastically deformable and configured to be detachably fastened in a recess in the holder, and wherein the sleeve has at least two sleeve subareas which are at least partially separable from one another, and wherein the sleeve subareas are connectable to one another, the method comprising:
providing the fastening device in a preinstalled state in which the sleeve subareas are at least partially separated from one another;
inserting the cable into an inner area of the sleeve;
connecting the sleeve subareas in an installed state in such a way that the cable is completely annularly enclosed by the sleeve subareas which are connected to one another; and
locking the sleeve in place on the holder.
